(19) United States
(12) Patent Application Publication
(10) Pub. No.: US 2014/0041115 A1
(43) Pub. Date: Feb. 13, 2014

(54) SINGLE SOURCE ASSEMBLY FOR HOME CARE OF PHYSICALLY IMPAIRED

(71) Applicant: Gordon Industries Inc., South Boston, MA (US)

(72) Inventor: Julian D. Gordon, Marblehead, MA (US)

(73) Assignee: Gordon Industries Inc., South Boston, MA (US)

(21) Appl. No.: 14/058,720

(22) Filed: Oct. 21, 2013

Related U.S. Application Data
(63) Continuation of application No. 13/386,195, filed on Oct. 15, 2012.
(60) Provisional application No. 61/227,165, filed on Jul. 21, 2009.

(51) Int. Cl. A61G 7/10

(52) U.S. Cl. CPC A61G 7/1025
USPC 5/87.1; 5/83.1

(57) ABSTRACT

A method of facilitating the establishment of a home care facility for the physically impaired by establishing a single source for a body lift assembly, portable shower and portable commode all suitable for installation in a bedroom and wherein the lift assembly is capable of transporting the impaired person between the bed, shower and commode.

This application is filed claiming the benefit of Applicant's U.S. provisional application Ser. No. 61/227,165, filed Jul. 21, 2009.

### BACKGROUND OF INVENTION

1. Field of Invention

This invention relates to a method of facilitating the establishment of a home care facility for the physically impaired and more particularly comprises establishing a single source for a body lift assembly, shower, commode, ramp and stair assembly that may be installed in the home to accommodate the needs of the impaired.

### SUMMARY OF INVENTION

As people age they frequently express a strong preference to spend their time at home in familiar surroundings and avoid being moved to a nursing home or other long term care facility. Independently funded facilities unsubsidized by local, state or federal government are extremely expensive, costing several thousands of dollars monthly. On the other hand, government owned facilities require residents to turn over all their assets and social security future income, because eligibility to move into such facilities requires that an applicant be indigent. Furthermore, such facilities are frequently overcrowded with 2, 3, 4, or even more individuals assigned to a single room frequently resulting in a total loss of privacy and the inability to listen to radio or television or receive private phone calls and may further create an intolerable noise level. Yet another distasteful if not unbearable condition is created by the incontinent residents that generate an odor that is both unhealthy and very distasteful for all residents of the institution. All of the foregoing factors create a strong preference on the part of the impaired to remain at home, hopefully with family, in familiar surroundings.

The present invention makes it relatively easy, convenient, and economically affordable for the family or other caregivers of the physically impaired to establish suitable quarters in the home. The different types of equipment required to do so are known, but heretofore have not been available from a single source.

A home facility for the physically impaired should include in a convenient and familiar location, typically a bedroom, with not only a suitable bed or other sleeping facility that is comfortable for the patient, but a commode, shower, and lift system to transport the person from each station including the bed to each of the others. In accordance with the present invention, the lift, shower and commode, along with the possible addition of a ramp to provide access to the living area of the home and stairs to bypass the ramp if the permanent stairs are blocked by the ramp, are provided by a single source.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

### SUMMARY OF INVENTION

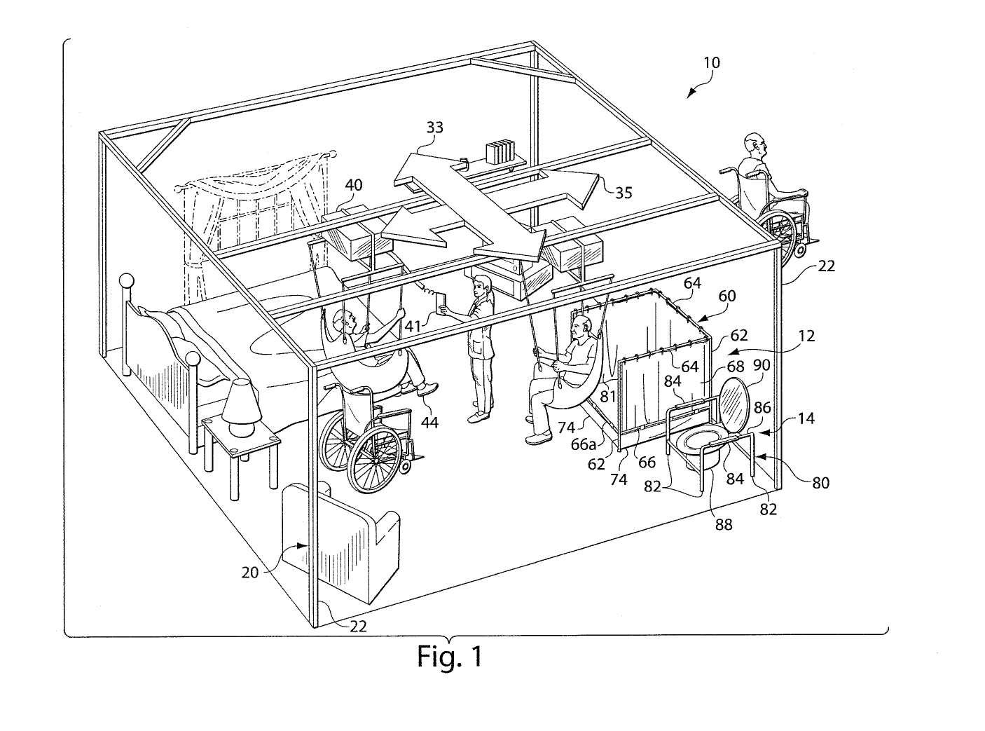

FIG. 1 is a pictorial illustration of a bedroom with a lift system, shower and commode supplied by a single source in accordance with the present invention and suggests the manner in which the various components function together;

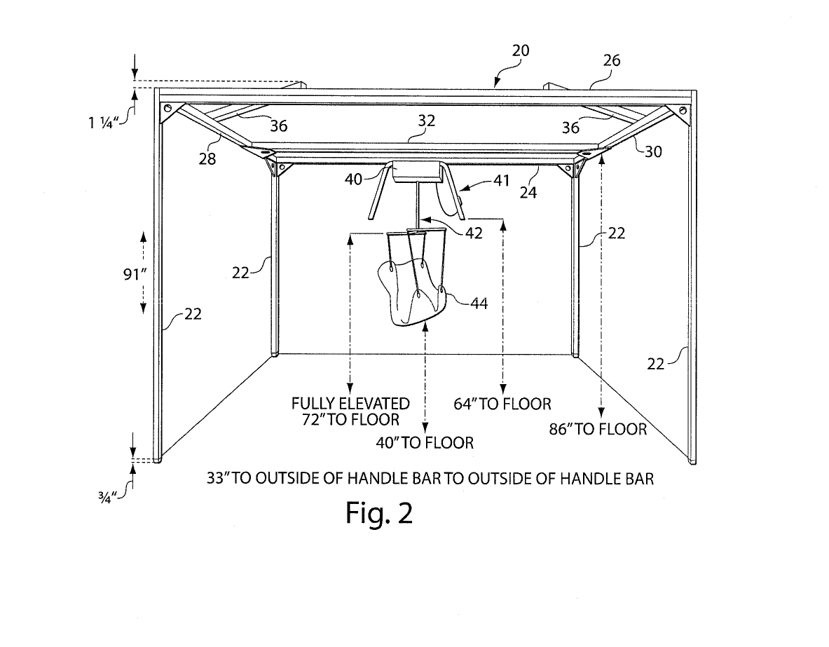

FIG. 2 is a perspective view of the lift system employed in the room of FIG. 1; and

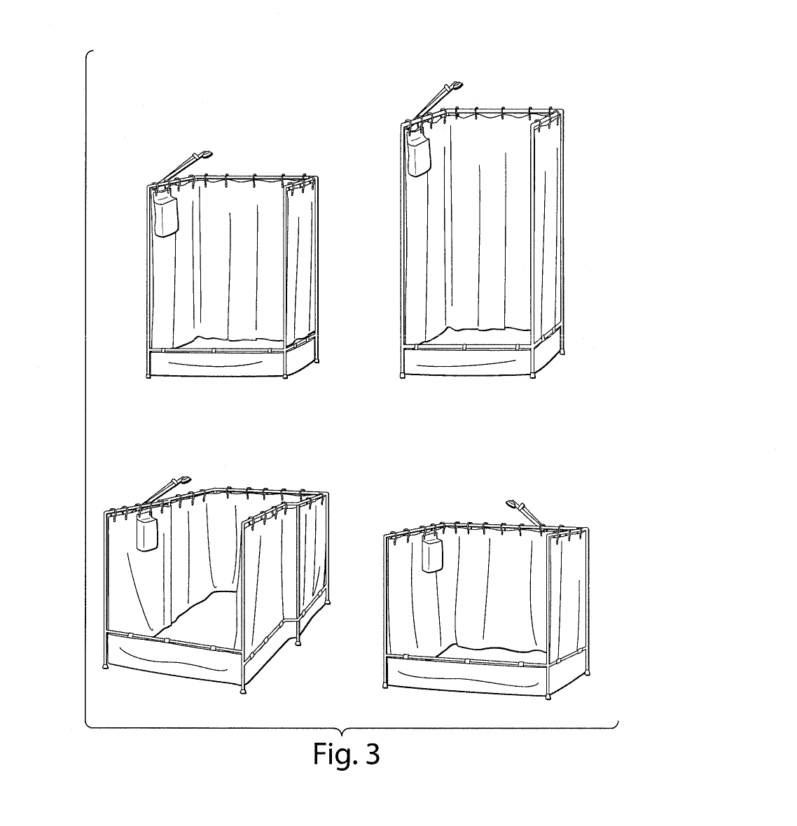

FIG. 3. illustrates an array of different shower stalls, any of which may be used in the combination of FIG. 1.

### DETAILED DESCRIPTION

FIG. 1 illustrates the combination of equipment to be supplied, either by sale or lease, by a sole source, to the physically impaired party in need of the equipment. In the drawing the lift system 10, shower 12, and commode 14 are shown. These various components are directly supplied by a single source to the impaired or his/her caregiver for home use. Each of the several components may be produced in a variety of different styles but their basic functions are well known. This application therefore, is not specifically confined to a particular style of any of the components, but rather the essence of the invention is the creation of a single source that supplies the lift, shower and commode for use by the impaired individual and his/her caregiver. Therefore, specific details described in the specification of the components are not intended to be limiting, but rather are given merely as examples of the individual components that are supplied.

The lift system 10 is the most complex of the various components. In FIG. 2, one example of a suitable lift system is shown in detail. The lift system includes a free-standing frame 20 that preferably does not require attachment to the walls, ceiling or floor of the room in which it is assembled, but rather is supported by corner posts 22 connected by horizontal beams 24, 26, 28, and 30 at the top four sides of the frame. The top beams 24 and 26 serve as stabilizers for the frame while the beams 28 and 30 serve as side tracks for a transverse beam 32 that is movable in the frame between the beams 24 and 26. As shown in FIG. 2, angle braces 36 interconnect the stabilizing beam 26 with the side beams 28 and 30 to stiffen the assembly. The side beams 28 and 30 enable the transverse beam 32 to move from front to back in the frame as viewed in FIGS. 1 and 2 and as suggested by arrow 33 in FIG. 1. FIG. 1 suggests two of the infinite number of positions that the transverse beam may assume to transport the individual about the room to the several components.

The sliding transverse beam 32 carries a motor lift assembly 40 that is movable on the transverse beam between the side beams 28 and 30 as suggested by arrow 35 in FIG. 1. As shown in FIGS. 1 and 2, the motor and lift assembly 40 carries a remote control and on/off switch 41 (shown in the hands of a caregiver) to enable the impaired person or caregiver to move the motor and lift assembly 40 on the transverse beam and also to move the transverse beam 32 back to front on the beams 28 and 30. As shown in FIG. 2, the lift assembly 40 carries a shackle 42 that in turn supports a sling 44 or other type of carrier for the person requiring use of the system to be moved about the room. While a sling is shown as the carrier, it should be appreciated that it may take the form of a seat, stretcher, or other support capable of transporting a person.

The shower 12 shown in FIG. 1 includes a frame 60 having four vertical legs 62 connected by upper horizontal bars 64 and lower horizontal bars 66. The shower is enclosed by a curtain 68 carried on hooks that engage the upper horizontal bars, and similar hooks may also connect the curtain to the vertical bars 62 to retain the curtain in place. The shower shown also includes a floor mat 74 that at its sides 75 extend upwardly to the lower horizontal bars 66 of the frame 60 to retain water within the confines of the shower. The shower shown is open at the front side, and the lower horizontal bar on that side 66a may be pivoted upwardly out of the way to afford access to a wheelchair and occupant to the shower interior. The shower may include a showerhead and hose connected to a water source such as faucet or tank, as well as a vacuum system for gathering water that collects on the floor mat and carry it to an appropriate collection device such as a tub or tank. These features are shown in the several shower embodiments in FIG. 3.

If the user is transported to the shower by means of the lift system 10, it may be necessary to remove one of the horizontal bars 64 to provide access through the open front 81. It is also desirable that the frame of the shower be collapsible so that it may be stored out of the way when not in use. Several typical embodiments of shower stalls intended for use at home by the impaired and suitable for use in this system are shown in FIG. 3.

The commode 14 may be a simple structure having a frame 80 that includes legs 82, arm rests 84, back brace 86, removable receptacle 88 and backrest 90. The receptacle should be readily removable so as to be emptied and cleaned. As with the other components of the home care system, other styles and designs of the various components supplied by a single source may be incorporated. The frame 80 may be made of metal or plastic. The model shown is only exemplary, and many other styles may be substituted.

The single source, in accordance with the present invention, may also supply ramp systems such as depicted in Applicant's earlier U.S. Pat. No. 5,740,575 granted Apr. 21, 1998, that is incorporated herein by reference. The ramp shown in Applicant's earlier patent may provide access to the home of an impaired person to facilitate the home care of the physically impaired person. Another structure that may further assist the caregiver in maintaining the impaired at home is an assembled stair structure such as shown in Applicant's copending application Ser. No. 12/469,781 filed May 21, 2009 incorporated herein by reference that may be temporarily erected to provide additional access to a home, particularly where a ramp system such as shown in Applicant's earlier U.S. Pat. No. 5,740,575 covers or blocks permanent and convenient stair access to the home.

Having described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of providing home care for a physically impaired person, comprising:
controlling a patient lift system to automatically move the physically impaired person in a horizontal direction between separate facilities of a room without exertion from the physically impaired person.

2. The method as set forth in claim 1, wherein controlling the patient lift system comprises operating a motor lift assembly that is motor powered and configured to move a patient between the separate facilities of the room.

3. The method of claim 2, wherein operating the motor lift assembly comprises carrying the motor lift assembly on a sliding transverse beam.

4. The method of claim 3, wherein carrying the motor lift assembly comprises moving the motor lift assembly along the sliding transverse beam.

5. The method of claim 4, wherein moving the motor lift assembly comprises moving the sliding transverse beam along oppositely positioned horizontal beams.

6. The method of claim 5, wherein controlling the patient lift system comprises controlling a position of the motor lift assembly along the sliding transverse beam and a position of the sliding transverse beam along the oppositely positioned horizontal beams.

7. The method of claim 1, wherein controlling the patient lift system comprises automatically moving the physically impaired person between a portable shower stall and a portable commode.

8. A method of providing for a physically impaired person, comprising:
controlling a patient lift system to move the impaired person between separate facilities of a room without exertion from the physically impaired person, wherein the patient lift system includes a frame having a plurality of posts for supporting the frame and each of the posts having an end that extends freely from a portion of the frame.

9. The method as set forth in claim 8, wherein controlling the patient lift system comprises automatically moving the physically impaired person in a horizontal direction between separate facilities of the room.

10. A home care facility, comprising:
a patient lift system configured to automatically move a physically impaired person in a horizontal direction between separate facilities of a room without exertion from the physically impaired person.

11. The home care facility of claim 10, further comprising a controller configured to control movement of the patient lift system in the horizontal direction between the separate facilities of the room.

12. The home care facility of claim 10, wherein the patient lift system includes a free-standing frame operable without attachment to a wall or ceiling of the room where the physically impaired person is located.

13. The home care facility of claim 12, wherein the frame includes a plurality of posts for supporting the frame and each of the posts having an end that extends freely from a portion of the frame.

14. The home care facility of claim 13, wherein the plurality of posts are disposed at respective corners of the frame.

15. The home care facility of claim 12, wherein the frame comprises a plurality of horizontal beams constructed to be disposed at an upper region of the frame.

16. The home care facility of claim 12, wherein the frame is supported by a floor, a ceiling or wall of the room.

17. The home care facility of claim 10, wherein the separate facilities of the room are located under a travel area of the patient lift system.
